(19) United States
(12) Patent Application Publication
(10) Pub. No.: US 2018/0150784 A1
(43) Pub. Date: May 31, 2018

(54) MACHINE LEARNED VECTOR MODELLING FOR RECOMMENDATION GENERATION

(71) Applicant: LinkedIn Corporation, Sunnyvale, CA (US)

(72) Inventors: Jian Wang, Los Altos, CA (US); Krishnaram Kenthapadi, Sunnyvale, CA (US); David Hardtke, Oakland, CA (US)

(21) Appl. No.: 15/362,576

(22) Filed: Nov. 28, 2016

(51) Int. Cl. G06Q 10/06; G06N 5/02; G06Q 50/00

(52) U.S. Cl. CPC G06Q 10/063112; G06Q 50/01; G06N 5/02

(57) ABSTRACT

Apparatuses, computer-readable medium, and methods are disclosed for generating machine learned models and recommendations identified using hidden feature vectors determined using the machine learned models. The method includes selecting a first job profile associated with a first set of members of a social networking system. The method identifies at least one second job profile associated with a second set of members and generates a vector model for the first job profile. The vector model identifies a set of hidden feature vectors for the first job profile. The method determines a job recommendation based on the first job profile, the at least one second job profile, the vector model, and a selected member profile. The method then causes presentation of the job recommendation on a display device of a computing device associated with the selected member profile.

### TECHNICAL FIELD

The subject matter disclosed herein generally relates to the technical field of special-purpose machines that facilitate machine learning techniques for vector modelling within a network service, including software-configured computerized variants of such special-purpose machines and improvements to such variants, and to the technologies by which such special-purpose machines become improved compared to other special-purpose machines that facilitate generating machine learned vector models to identify latent vectors within a database and generate recommendations using the latent vectors.

### BACKGROUND

Many data retrieval systems, such as social networking and search systems, employ content-based models to surface search results and retrieve content stored on the data retrieval system for recommendations. Some systems use structured fields for data storage and categorization of content to enable recall of documents by content-based recall models. The structured fields are often incorporated into the content-based models within a static feature space. These content-based models are based primarily on explicit user context and fail to incorporate implicit user context. Display of inaccurate or unsuitable matches or results due to incomplete context discourages users from engaging with the data retrieval system. Further, content-based models become computationally demanding where the data retrieval system includes large numbers of data elements to potentially be compared, parsed, and selected for inclusion within a set of results.

### DESCRIPTION OF THE DRAWINGS

Some embodiments are illustrated by way of example and not limitation in the figures of the accompanying drawings, in which:

FIG. 1 is a block diagram of a social networking system, in accordance with some embodiments;

FIG. 2 illustrates a job recommendation engine, in accordance with some embodiments;

FIG. 3 illustrates the similarity component of the job recommendation engine, in accordance with some embodiments;

FIG. 4 illustrates a method for generating job recommendations, in accordance with some embodiments;

FIG. 5 illustrates a method for generating job recommendations, in accordance with some embodiments;

FIG. 6 illustrates a method for generating job recommendations, in accordance with some embodiments;

FIG. 7 illustrates a method for generating job recommendations, in accordance with some embodiments; and

FIG. 8 shows a diagrammatic representation of a machine in the example form of a computer system and within which instructions (e.g., software) for causing the machine to perform any one or more of the methodologies discussed herein may be executed.

### DETAILED DESCRIPTION

The present disclosure describes methods, systems and computer program products for improving the generating of job recommendations. In the following description, for purposes of explanation, numerous specific details are set forth in order to provide a thorough understanding of the various aspects of different embodiments of the present invention. It will be evident, however, to one skilled in the art, that the present inventive subject matter may be practiced without all of the specific details and/or with variations, permutations, and combinations of the various features and elements described herein.

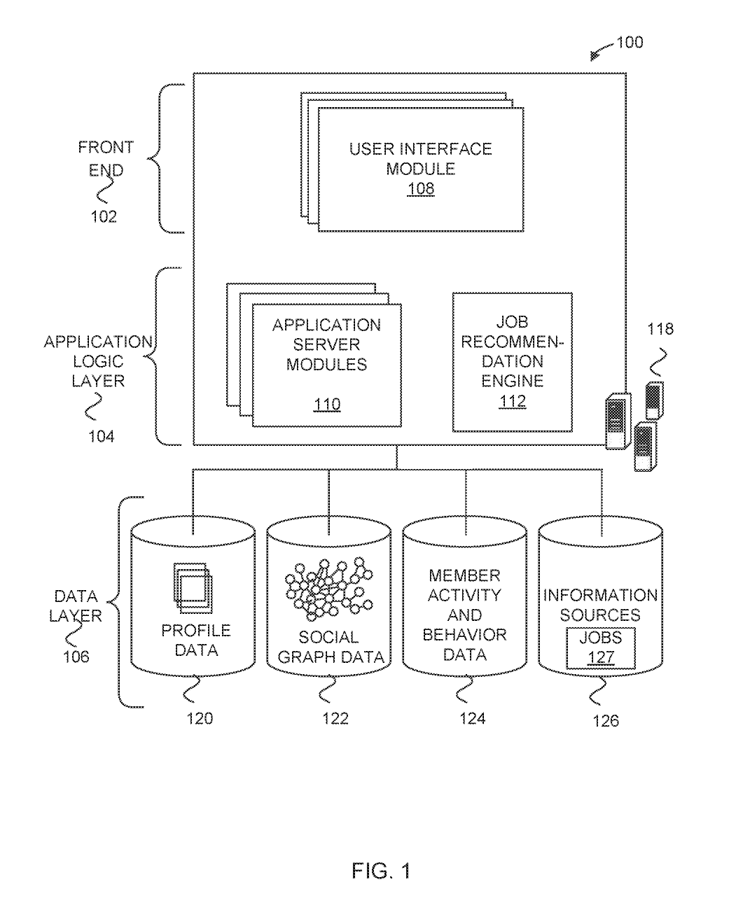

FIG. 1 is a block diagram of a social networking system 100 in accordance with some embodiments. The social networking system 100 may be based on a three-tiered architecture, comprising a front-end layer 102, application logic layer 104, and data layer 106. Some embodiments implement the social networking system 100 using different architectures. The social networking system 100 may be implemented on one or more computers 118. The computers 118 may be servers, personal computers, laptops, portable devices, etc. The social networking system 100 may be implemented in a combination of software, hardware, and firmware.

As shown in FIG. 1, the front-end layer 102 includes user interface modules 108. The user interface modules 108 may be one or more web services. The user interface modules 108 receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing web browser applications, or applications that have been developed for a specific platform to include any of a wide variety of mobile devices and operating systems.

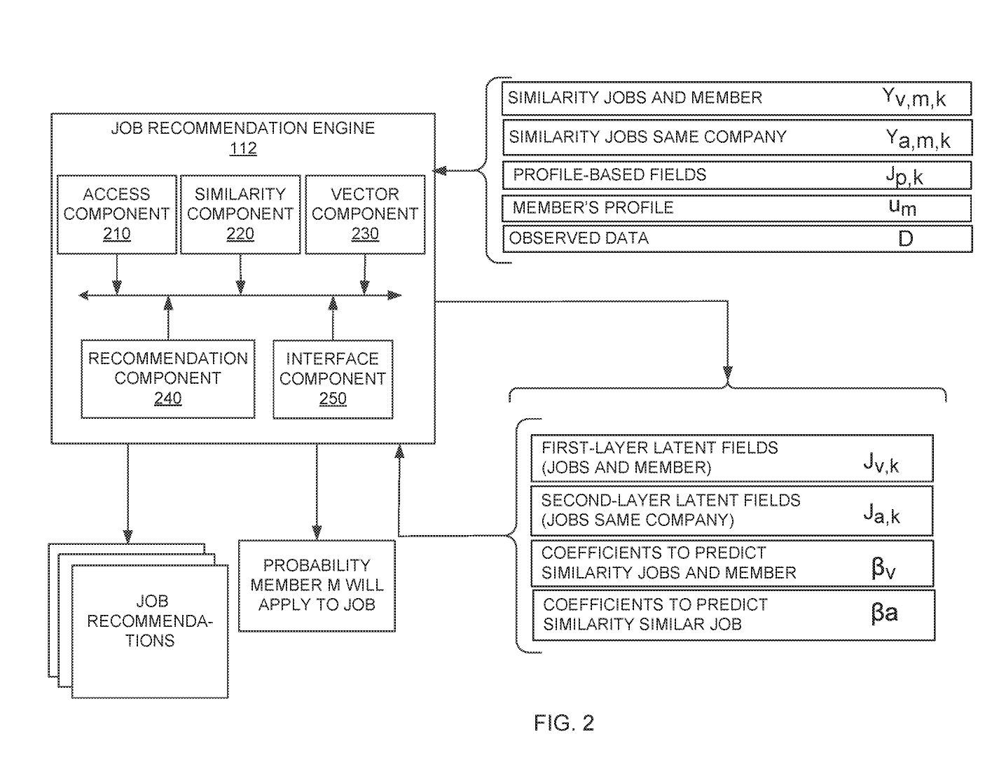

As shown in FIG. 1, the data layer 106 includes profile data 120, social graph data 122, member activity and behavior data 124, and information sources 126. Profile data 120, social graph data 122, and member activity and behavior data 124, and/or information sources 126, may be databases. One or more of the data layer 106 may store data relating to various entities represented in a social graph. In some embodiments, these entities include members, companies, and/or educational institutions, among possible others. Consistent with some embodiments, when a person initially registers to become a member of the social networking system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in profile data 120. The profile data 120 may include a vector of fields associated with the member m. The fields of the vector of fields may represent attributes of the member's profile. The attributes may comprise demographic information, interests, contact information, skills, educational background, job titles (e.g., current and former), industry information, and other suitable information provided by the member or gleaned from the information provided by the member. The vector of fields (e.g., the member's profile) may be represented as uₘ (see FIG. 2).

With some embodiments, a member's profile data 120 will include not only the explicitly provided data, but also any number of derived or computed member profile attributes and/or characteristics, which may become part of one of more of profile data 120, social graph data 122, member activity and behavior data 124, and/or information sources 126. The derived member profile attributes may be included in the representation, uₘ, of the member's profile. Table 1 is an example of member's profile uₘ fields.

TABLE 1
EXAMPLE MEMBER PROFILE FIELDS

<sourceField entityType=“MEMBER” name=“associations”>
<sourceField entityType=“MEMBER” name=“current functions”>
<sourceField entityType=“MEMBER” name=“current normalized title
seniority years”/>
<sourceField entityType=“MEMBER” name=“current position
summary”>
<sourceField entityType=“MEMBER” name=“current title short form”>
<sourceField entityType=“MEMBER” name=“current title string”>
<sourceField entityType=“MEMBER” name=“current title”>
<sourceField entityType=“MEMBER” name=“current company name”>
<sourceField entityType=“MEMBER” name=“Custom plus latent
preferences with regard to location”>
<sourceField entityType=“MEMBER” name=“custom plus latent
preferences with regard to senority”>
<sourceField entityType=“MEMBER” name=“degrees”>
<sourceField entityType=“MEMBER” name=“education notes”>
<sourceField entiryType=“MEMBER” name=“headline”>
<sourceField entityType=“MEMBER” name=“honors”>
<sourceField entityType=“MEMBER” name=“interests”>
<sourceField entityType=“MEMBER” name=“job seniority previous
jobs”>
<sourceField entityType=“MEMBER” name=“past functions”>
<sourceField entityType=“MEMBER” name=“past position summary”>
<sourceField entityType=“MEMBER” name=“past title string”>
<sourceField entityType=“MEMBER” name=“past titles”>
<sourceField entityType=“MEMBER” name=“location”>
<sourceField entityType=“MEMBER” name=“preferences company
size”/>
<sourceField entityType=“MEMBER” name=“preferences industry
category”/>
<sourceField entityType=“MEMBER” name=“preferences location”/>
<sourceField entityType=“MEMBER” name=“preferences seniority”/>
<sourceField entityType=“MEMBER” name=“resolved company size”>
<sourceField entityType=“MEMBER” name=“resolved country”/>
<sourceField entityType=“MEMBER” name=“resolved industry
category”>
<sourceField entityType=“MEMBER” name=“standardized skills as
string”>
<sourceField entityType=“MEMBER” name=“standardized skills”>
<sourceField entityType=“MEMBER” name=“summary”>

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a “connection”, the concept of“following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data 122. With some embodiments, the social graph data 122 may be implemented with a graph database, which is a particular type of database that uses graph structures with nodes, edges, and properties to represent and store data. In this case, the social graph data 122 reflects the various entities that are part of the social graph, as well as how those entities are related with one another.

With various alternative embodiments, any number of other entities might be included in the social graph data 122, and as such, various other databases may be used to store data corresponding with other entities. For example, although not shown in FIG. 1, consistent with some embodiments, the system may include additional databases for storing information relating to a wide variety of entities, such as information concerning various online or offline people, job announcements, companies, groups, posts, slideshares, and so forth.

With some embodiments, the application server modules 110 may include one or more activity and/or event tracking modules, which generally detect various user-related activities and/or events, and then store information relating to those activities/events in, for example, member activity and behavior data 124. For example, the tracking modules may identify when a user makes a change to some attribute of his or her member profile, or adds a new attribute. Additionally, a tracking module may detect the interactions that a member has with different types of content. For example, a tracking module may track a member's activity with respect to job announcements, e.g., job announcement views, saving of job announcements, applications to a job in a job announcement, explicit feedback regarding a job announcement (e.g., not interested, not looking, too junior, not qualified, information regarding the job the member would like, a location where a member wants to work, does not want to move, wants more like this, etc.), job search terms that may be entered by a member to search for job announcements. Such information may be used, for example, by one or more recommendation engines to tailor the content presented to a particular member, and generally to tailor the user experience for a particular member.

Information sources 126 may be one or more additional information sources. For example, information sources 126 may include ranking and business rules, historical search data, and reference data as well as people, jobs 127, which may include one or more job profiles, job announcements (not illustrated), etc. The one or more job profiles comprise job profile data for each job represented within the social networking system 100. The job profile data may include a job profile, an observed similarity between a user and a job y_{ν,m,k}, an observed similarity between a user associated with a similar job and the job y_{a,m,k}, a vector of first-layer latent fields associated with the job j_{ν,k}, a vector of second-layer latent fields associated with the job j_{a,k}, coefficients to predict similarity between the job and members β_{ν}, and coefficients to predict similarity between the job and members having a similar job βₐ. The observed similarity between the user (e.g., member) and the job k y_{ν,m,k} may indicate a member's current position is similar to a job k where y_{ν,m,k}=1. Where the member's current position is not similar to the job k, y_{ν,m,k}=−1. The observed similarity between the user (e.g., member) and a job determined to be similar to job k y_{a,m,k} may indicate a member's current position is similar to the similar job where y_{a,m,k}=1. Where the member's current position is not similar to the similar job, y_{a,m,k}=−1. In some embodiments, as described above, with respect to member profiles, the job profile includes any number of derived or computed job profile attributes or characteristics. These calculated attributes or characteristics become part of the job profile data. An example of derived or calculated attributes or characteristics is a vector of profile-based fields associated with the job j_{p,k}.

In some embodiments, the job profile j_{p,k} is vector fields or features associated with job k of jobs 127. The vector includes static features that are derived from the job description, e.g., job title, qualifications, job location, etc. The job profile j_{p,k} may be stored in information sources 126. The job profile j_{p,k} is a profile of a job 127, which, in some embodiments, has one or more job announcements or postings associated with the job profile j_{p,k} or job 127. Table 2 illustrates example fields of the job profile j_{p,k}.

TABLE 2
EXAMPLE JOB PROFILE FIELDS

<targetField entityType=“JOB” name=“listing type”/>
<targetField entityType=“JOB” name=“job seniority”/>
<targetField entityType=“JOB” name=“industry category”/>
<targetField entityType=“JOB” name=“company size”/>
<targetField entityType=“JOB” name=“company locations”/>
<targetField entityType=“JOB” name=“job opening locations”/>
<targetField entityType=“JOB” name=“job seniority minimum”/>
<targetField entityType=“JOB” name=“geographical country”/>
<targetField entityType=“JOB” name=“skills”>
<targetField entityType=“JOB” name=“description of job”>
<targetField entityType=“JOB” name=“company Description”>
<targetField entityType=“JOB” name=“functions to be performed”>
<targetField entityType=“JOB” name=“job seniority preferred”>
<targetField entityType=“JOB” name=“standardized skills required”>
<targetField entityType=“JOB” name=“relevant standardized skills”>
<targetField entityType=“JOB” name=“job title”>
<targetField entityType=“JOB” name=“job title as a string”>
<targetField entityType=“JOB” name=“industry category”>

In some embodiments, observed data D is observed data of all jobs k, e.g., D={D₁, . . . , Dₖ, . . . , D_{K}}. The observed data D is stored in the member activity and behavior data 124 in accordance with some embodiments. In some embodiments, Dₖ={y_{ν,m,k}, y_{a,m,k}, uₘ, j_{p,k}} is a set of observed data associated with job k. Each observation is associated with four parts: similar users and job y_{ν,m,k} similar users to jobs determined to be similar to job y_{a,m,k}, member's profile uₘ, and profile-based fields j_{p,k}. In some embodiments, the Dₘ is stored in the member activity and behavior data 124.

The application server modules 110, in conjunction with the user interface module 108, generate various user interfaces (e.g., web pages) with data retrieved from the data layer 106. In some embodiments, individual application server modules 110 are used to implement the functionality associated with various applications, services, and features of the social networking service. For instance, a messaging application, such as an email application, an instant messaging application, or some hybrid or variation of the two, may be implemented with one or more application server modules 110. Of course, other applications or services may be separately embodied in their own application server modules 110. In some embodiments applications may be implemented with a combination of application server modules 110 and user interface modules 108. For example, a job recommendation engine 112 may be implemented with a combination of back-end modules, front-end modules, and modules that reside on a user's computer 118. For example, the social networking system 100 may download a module to a web browser running on a user's computer 118, which may communicate with a module running on a server, which may communicate with a module running on a back-end database server.

The social networking system 100 may provide a broad range of applications and services that allow members the opportunity to share and receive information, often customized to the interests of the member. For example, with some embodiments, the social networking system 100 may include a photo sharing application that allows members to upload and share photos with other members. As such, at least with some embodiments, a photograph may be a property or entity included within a social graph. With some embodiments, members of a social networking service may be able to self-organize into groups, or interest groups, organized around a subject matter or topic of interest. Accordingly, the data for a group may be stored in social graph data 122. When a member joins a group, his or her membership in the group may be reflected in the social graph data 118, a member's profile uₘ, a job profile j_{p,k}, and a feature vector associated with both a member profile and the job x_{m,k}. In some embodiments, members may subscribe to or join groups affiliated with one or more companies. For instance, with some embodiments, members of the social networking service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and structured with the social graph data 122, and may be reflected in the a member's profile uₘ, the job profile j_{p,k}, and the feature vector associated with both a member profile and the job x_{m,k}.

In addition to the various application server modules 110, the application logic layer 104 includes a job recommendation engine 112. As illustrated in FIG. 1, with some embodiments the job recommendation engine 112 is implemented as a service that operates in conjunction with various application server modules 110 and user interface modules 108. For instance, any number of individual application server modules 110 can invoke the functionality of the job recommendation engine 112. However, with various alternative embodiments, the job recommendation engine 112 may be implemented as its own application server module 110 such that it operates as a stand-alone application.

The job recommendation engine 112 may search the data layer 106 and determine jobs 127 to present to a member. In some embodiments, the job recommendation engine 112 may determine jobs 127 that should not be presented to a member. In some embodiments, the job recommendation engine 112 works offline to prepare jobs 127 to present to a member. In some embodiments, the job recommendation engine 112 may be used by a recruiter to generate a list of members that may be interested in a particular job 127. The recruiter may pay to push the job 127 to the member or members.

In some example embodiments, the job recommendation engine 112 includes or has an associated publicly available application programming interface (API) that enables third-party applications to invoke the functionality of the job recommendation engine 112.

As is understood by skilled artisans in the relevant computer and Internet-related arts, each engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as the system 100 illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the disclosed embodiments are by no means limited to such architecture.

FIG. 2 illustrates a job recommendation engine 112 in accordance with some embodiments. In some example embodiments, the job recommendation engine 112 comprises an access component 210, a similarity component 220, a vector component 230, a recommendation component 240, and an interface component 250. All, or some, of the components 210-250 communicate with each other, for example, via a network coupling, shared memory, and the like. Each component of components 210-250 can be implemented as a single component, combined into other components, or further subdivided into multiple components. Other components not pertinent to example embodiments can also be included, but are not shown.

The access component 210 selects, accesses, or otherwise receives job profile information from the social networking system 100. In some example embodiments, the access component 210 selects the job profile in coordination with one or more other components. For example, in some instances, the access component 210 selects the job profile in response to receiving a user interface selection from the interface component 250 indicating selection of a user interface element by a user of a computing device. The selection of the user interface element may indicate a desire to access, view, share, or otherwise interact with the job profile. In some instances, after selecting the job profile, the access component 210 transmits the job profile, or an indication thereof, to one or more other components of the job recommendation engine 112. In some embodiments, the access component 210 passes an indication of the selected job profile to one or more of the similarity component 220 and the vector component 230.

The similarity component 220 identifies and determines similarities between the selected job profile and one or more other job profiles on the social networking system 100. In some embodiments, the similarity component 220 determines or cooperates with another component to determine similarities between members of the social networking system 100. The similarity component 220 may identify job profiles as similar to the selected job profile by comparing attributes of the selected job profile to attributes of other job profiles within the social networking system 100. In some instances, the similarity component 220 generates similarity scores used by one or more other components of the job recommendation engine 112 to identify, parse, and cause presentation of job profiles to a user.

The vector component 230 generates vector models for job profiles of the social networking system 100. In some embodiments, the vector component 230 identifies hidden feature vectors for job profiles of the social networking system 100. In some embodiments, hidden feature vectors represent elements, attributes, or other aspects common to member profiles associated with the job profile. In some instances, the vector component 230 generates a vector model for a job profile using one or more equations interpreting and analyzing two or more job profiles and one or more member profiles associated with each of the two or more job profiles.

In some example embodiments, the vector component 230 uses one or more equations to determine model parameters for a vector model. A first sub-component specifies parameter likelihoods in the vector model. In some embodiments, the parameter comprises a coefficient to predict similarity between the job and members β_{ν} (e.g., a first coefficient) and a coefficient to predict similarity between the job and members having a similar job βₐ (e.g., a second coefficient). The first coefficient β_{ν} and the second coefficient βₐ may be coefficients for a regression model (e.g., the vector model). In some embodiments, the first sub-component determines parameters comprising a first variance coefficient σ_{ν} and a second variance coefficient σₐ. The first variance coefficient controls the distribution from which first-layer latent fields for the job are drawn. The second variance coefficient controls the distribution from which second-layer latent fields are drawn. The first-layer latent fields may be represented as the vector of first-layer latent fields associated with the job j_{ν,k}. The second-layer latent fields may be represented as the vector of second-layer latent fields associated with the job j_{a,k}. In some example embodiments, the first sub-component determines the first coefficient and the first variance coefficient jointly (e.g., first regression coefficients), and determines the second coefficient and the second variance coefficient jointly (e.g., second regression coefficients). In some instances, the first sub-component determines the first coefficient, the second coefficient, the first variance coefficient, and the second variance coefficient jointly. The parameters may be sampled from a Gaussian distribution.

In some example embodiments, the first sub-component uses Equations (1a), (1b), (1c), and (1d) to determine the first coefficient, the second coefficient, the first variance coefficient, and the second variance coefficient.

β_{ν}˜N(μ_{βν},σ_{βν}) Equation (1a):

βₐ˜N(μ_{βa},σ_{βa}) Equation (1b):

σ_{ν}˜N(μ_{σν},σ_{σν} Equation (1c):

σₐ˜N(μ_{σa},σ_{σa}) Equation (1d):

In some instances, the Equations (1a), (1b), (1c), and (1d) may be denoted as ϕ=(μ_{βν}, σ_{βν}, μ_{βa}, μ_{βa}, μ_{σν}, σ_{σν}, μ_{σa}, α_{σa}).

In some example embodiments, the vector component 230 uses one or more equations to determine job feature vectors for the vector model. Lowercase M is used to indicate the index of the member for 1, 2, . . . , M members. Lowercase K is used to indicate the index of the job for 1, 2, . . . , N jobs. A second sub-component specifies likelihoods of the job feature vectors. The second sub-component extracts the profile-based fields j_{p,k} from a static job profile for which the vector model is being generated. The second sub-component then identifies the first-layer latent fields j_{ν,k}, and the second-layer latent fields j_{a,k}. The first-layer latent fields j_{ν,k} may follow a Gaussian distribution with the profile-based fields j_{p,k} as a mean and have a variance according to the first variance coefficient σ_{ν}. The second-layer latent fields may follow the Gaussian distribution with the profile based fields j_{p,k} as a mean and have a variance according to the second variance coefficient σₐ. In these embodiments, the second sub-component uses Equations (2a) and (2b) to determine the first-layer latent fields and the second-layer latent fields.

j_{ν,k}˜N(j_{p,k},σ_{ν}) Equation (2a):

j_{a,k}˜N(j_{ν,k},σₐ) Equation (2b):

In some instances, a higher value for the first variance coefficient σ^{ν}, the less important the profile-based fields j_{p,k}. This may cause the vector model to give more weight to similar members associated with a job or members associated with a similar job than the fields of the job profile for which the vector model is being generated. The first variance coefficient σ_{ν} and the second variance coefficient σₐ may be tuned manually to control a weight of the fields received from the profile-based fields j_{p,k}. In some example embodiments, the first variance coefficient σ_{ν} and the second variance coefficient σₐ are tuned automatically by the vector component 230. In some instances of the example embodiments referenced above, the vector component 230 automatically tunes the first variance coefficient σ_{ν} and the second variance coefficient σₐ iteratively. As will be explained in more detail below, the iterative tuning of the first variance coefficient σ_{ν} and the second variance coefficient σₐ may be performed in combination or in coordination with automated iterative tuning of one or more of the first regression coefficients and the second regression coefficients. In these instances, the first sub-component and the second sub-component operate in coordination with one another to generate and tune the vector model.

In some example embodiments, using the first regression coefficients, the second regression coefficients, and the first-layer latent fields, the vector component 230 generates a list of features (e.g., hidden feature vectors) for the job profile. In some instances, the vector component 230 generates the output of features as the first-layer latent fields j_{ν,k}, and the second-layer latent fields j_{a,k}. In some instances, the second-layer latent fields j_{a,k} are provided as the output of hidden feature vectors for the job profile. The hidden feature vectors may be generated using the above equations and represent similarity comparisons of the job profile, one or more similar job profiles, one or more member profiles of members associated with the job profile, and one or more member profiles of members associated with the one or more similar job profiles. In some example embodiments, the vector component 230 identifies the first-layer latent fields j_{ν,k}, using Equation 3 and the second-layer latent fields j_{a,k} using Equation 4.

p(y_{ν,m,k}|j_{ν,k},β_{ν})=1/(1+exp(−y_{ν,m,k}(β_{ν}^{T}f(j_{ν,k},uₘ)))) Equation 3:

p(y_{a,m,k}|j_{a,k},βₐ)=1/(1+exp(−y_{a,m,k}(βₐ^{T}f(j_{a,k},uₘ)))) Equation 4:

Equations 3 and 4 specify a likelihood of observed similarities between the job profile, members associated with the job profile, and members associated with similar job profiles, respectively. In some instances, using Equation 3, the members determined to be similar to the job profile depends on the first-layer latent fields j_{ν,k} and the first coefficient β_{ν} (e.g., a vector model, regression model, or portion of a vector or regression model associated with the first coefficient). In some instances, using Equation 4, the members determined to be similar to the job profile depends on the second-layer latent fields j_{a,k} and the second coefficient βₐ (e.g., a vector model, regression model, or portion of a vector or regression model associated with the second coefficient).

In some example embodiments, the job recommendation engine 112 or the vector component 230 assumes the data is independently and identically distributed. In these instances, the vector component 230 represents the data likelihood using Equation 5.

$$\begin{matrix}p ( D \vert φ ) = \int p ( D , {θ}_{g} \vert φ ) d {θ}_{g} \\ = \int p ( D \vert {θ}_{g} , φ ) p ( {θ}_{g} \vert φ ) d {θ}_{g} \\ = \int [ {\prod }_{k = 1}^{M} p ( {y}_{k} \vert {θ}_{g} . φ ) ] p ( {θ}_{g} \vert φ ) d {θ}_{g}\end{matrix} \qquad Equation 5$$

As shown, in Equation 5, θ_{g} is equal to (βₐ, β_{ν}, σₐ, α_{ν}). Further, θ_{g} may be a random variable denoting joint distribution of the global random variables, βₐ, β_{ν}, σₐ, and σ_{ν}.

In some instances, the job recommendation engine 112 or the vector component 230 determines the data likelihood for job k (e.g., the job profile for which the vector model was generated) using Equation 6.

p(yₖ|θ_{g},ϕ)=∫p(yₖ|θₖ,θg,φ)*p(θₖ|θ_{g},ϕ)dθₖ Equation 6:

As shown, in Equation 6, p(yₖ|=θₖ,θ_{g}, φ)*p(θₖ|θ_{g}, ϕ)=ℏₘ₌₁^{M}^{ₖ}[p(y_{ν,m,k}|j_{ν,k},β_{ν})*p(y_{a,m,k}|j_{a,k},βₐ)]*p(j_{a,k}|j_{ν,k},σₐ)p(j_{ν,k}|σ_{ν}). In these instances, θₖ=(j_{ν,k}, j_{a,k}). Further, θₖ may be a random variable denoting joint distribution of the first-layer latent vector and the second-layer latent vector for the job k (e.g., the job profile for which the vector model was generated).

In some embodiments, the vector component 230 maximizes (e.g., determines a theoretical maximum for) a likelihood of p(D, φ). In some instances, maximizing the likelihood of p(D, φ) is equivalent to maximizing a log likelihood of Equation 7.

L(D|φ)=ln p(D|ϕ) Equation 7:

The vector component 230 may not use a closed-form solution for estimation of model parameters in the above described equations. In some embodiments, the vector component 230 generates an approximate solution using an iterative process. In some instances, the vector component 230 uses a Bayesian method in the iterative process. The vector component 230 thereby derives an Expectation-Maximization (EM) based iterative process to approximate the solution. In these instances, the Expectation (E) operation or set of operations holds constant (e.g., retains a fixed value) for the regression structures (e.g., first regression coefficients and second regression coefficients) described above, and the latent vectors are varied (e.g., iterated or tuned). In the Maximization (M) operation or set of operations, the vector component 230 holds constant (e.g., retains a fixed value) for the latent vectors and varies the regression structures described above. As described below, in some embodiments, the job recommendation engine 112, using one or more of the components, determines the first regression coefficients, the second regression coefficients, the first-layer latent vectors, and the second-layer latent vectors using the iteration process to generate a tuned vector model using Equation 6. The job recommendation engine 112 may use the tuned vector model to predict similarity of a member to a job profile, using the hidden feature vectors. In some embodiments, the job recommendation engine 112 uses the vector model to determine a probability that a member M will apply to a specified job.

The recommendation component 240 determines job recommendations for a specified member of the social networking system 100 based on one or more of a set of job profiles, a set of vector models, and a set of member profiles. The recommendation component 240 receives or otherwise accesses hidden feature vectors identified by the vector component 230 during generation and tuning of the vector model for the set of job profiles. The recommendation component 240 compares aspects, attributes, characteristics, or fields of a member profile of the specified member to the hidden feature vectors. In some embodiments, the recommendation component 240 determines a single job for inclusion in a job recommendation. In some instances, the recommendation component 240 determines a set of jobs for inclusion in a job recommendation and an order or rank for the set of jobs.

The interface component 250 causes presentation of the job recommendation on a display device of a computing device of the selected or specified member. In some embodiments, the interface component 250 causes presentation of the job recommendation by transmitting user interface data to the computing device. The user interface data may be configured to cause the computing device to depict the job recommendation on a display device associated with the computing device.

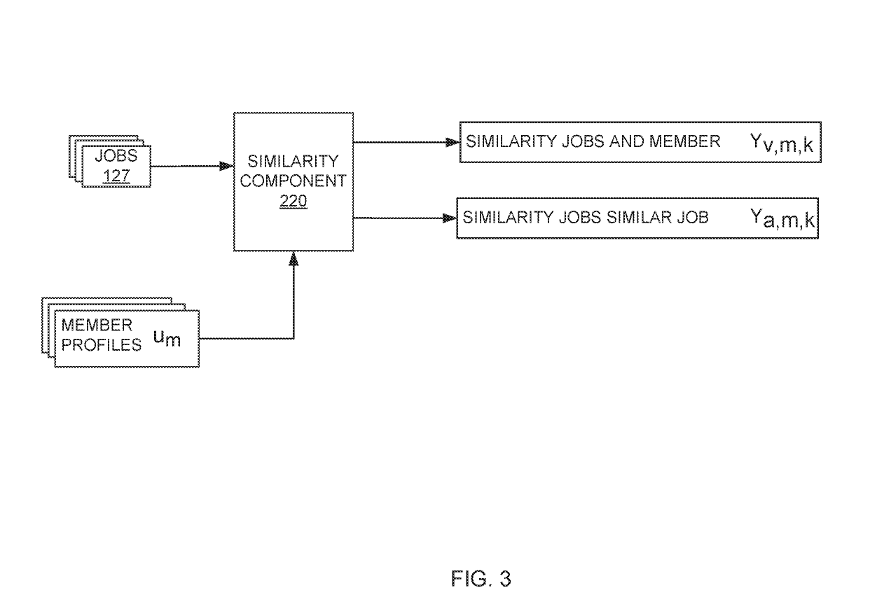

FIG. 3 illustrates the similarity component 220 in accordance with some embodiments. Illustrated in FIG. 3 is jobs 127, the similarity component 220, member's profile urn, the observed similarity between the user and the job y_{ν,m,k}, and the observed similarity between a user associated with a similar job and the job y_{a,m,k}. The similarity component 220 is configured to compare members with the member's profile uₘ and the profile-based fields j_{p,k} to determine observed similarity between the user and the job y_{ν,m,k}, and the observed similarity between a user associated with a similar job and the job y_{a,m,k}. The similarity component 220 compares fields of a current job or member profile (as indicated in the member's profile uₘ) with the kth job 127 with profile-based fields j_{p,k}, in accordance with some embodiments. For example, the similarity component 220 may compare a job title of Table 2 (job profile fields) with a job title of Table 1 (member profile fields). For the observed similarity between a user associated with a similar job and the job y_{a,m,k}, the similarity component 220 compares fields of the profile-based fields j_{p,k} with the member's profile uₘ to determine if it is the same job title, the same company, or otherwise similar.

In some embodiments, the similarity component 220 compares all of the fields of a current job or member profile (as indicated in the member's profile uₘ) with the kth job 127 with profile-based fields j_{p,k} and member profiles of members associated with the profile-based fields j_{p,k}. The similarity component 220 determines a score of closeness (e.g., a similarity score), in accordance with some embodiments. In some embodiments, the similarity component 220 builds a dictionary of synonyms that it uses to compare the fields. The dictionary of synonyms is built by determining relationships of words occurring in one or more of member profiles, job profiles, entity profiles, and categorical relationships (e.g., associations or hierarchical relationships) of the social networking system 100. For example, the similarity component 220 may determine a synonym relationship between two words where multiple member profiles or job profiles use one or both of the words interchangeably. By way of further example, the similarity component 220 may determine a synonym or other relationship between a first word and a second word where a portion of member profiles uses a first word and a portion of member profiles uses a second word, and the first word and the second word are determined to refer to a single concept, entity, or item. The dictionary of synonyms may also incorporate established semantic relationships (e.g., relationships indicated in a dictionary or thesaurus). In these embodiments, the dictionary of synonyms is generated as a data structure indicating relationships among words and groups of words (e.g., clusters of related words). In some instances, the similarity component 220 builds a hierarchy and ranking of terms to use to compare fields, e.g., “information technology” may be ranked as being closer to “developer” than “salesperson”. In some example embodiments, the similarity component 220 determines one or more first job profiles that are similar to a second job profile of the member of the social networking system 100 by comparing one or more fields of the one or more first job profiles with the second job profile and determining a score for how closely fields of the one or more fields match with fields of the second job profile.

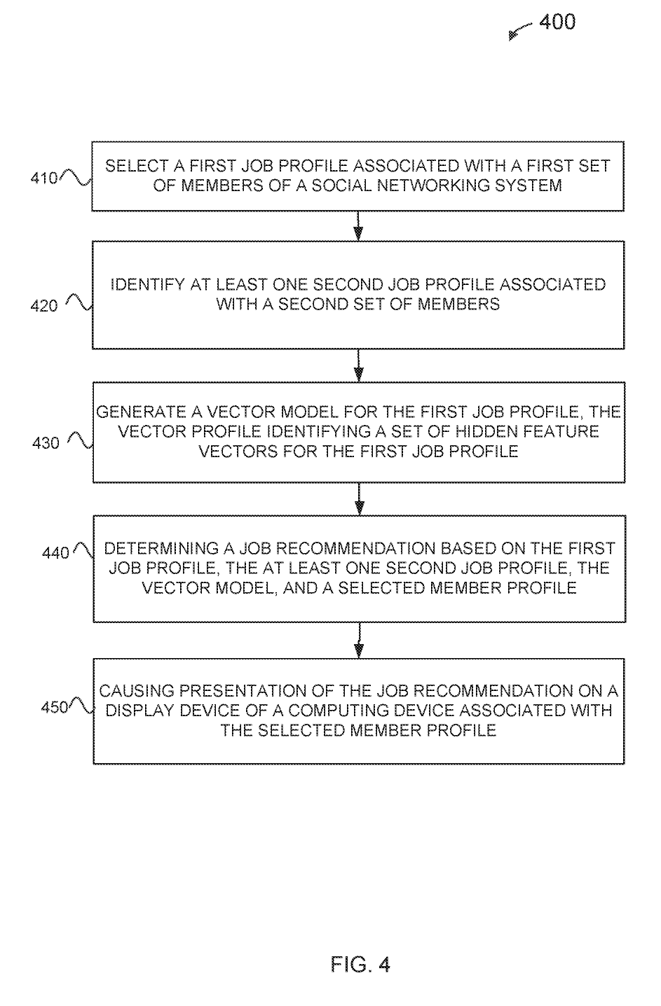

FIG. 4 illustrates a method 400 for generating job recommendations using hidden feature vectors and a generated vector model, in accordance with some embodiments. The operations of method 400 may be performed by components of the job recommendation engine 112, and are so described below for purposes of illustration.

In operation 410, the access component 210 selects a first job profile. The first job profile is associated with a first set of members of a social networking system. In some embodiments, the access component 210 selects the first job profile from a set ofjob profiles stored within the social networking system 100. The first job profile may be stored within the profile data 120 and accessible by the access component 210 within the social networking system 100 or via a network connection. In some embodiments, the access component 210 selects the first job profile based on input from a member of the social networking system 100. For example, the member from which the input is received may be one of the first set of members associated with the first job profile. In these instances, the member of the social networking system 100 causes a user device to transmit a user interface selection to one or more of the access component 210 and the interface component 250, indicating a request for the job recommendation engine 112. In some embodiments the request is a request for a job recommendation. In some instances, the request is generated after receiving an indication that the member is interested in a job. For example, where the member selects a user interface element representing a job search or jobs of potential interest, one or more of the access component 210 and the interface component 250 receives the selection and causes the access component 210 to select the first job profile.

In operation 420, the similarity component 220 identifies at least one second job profile. The at least one second job profile is associated with a second set of members of the social networking system 100. In some embodiments, the similarity component 220 identifies the at least one second job profile by determining at least one similarity between the first job profile and the at least one second job profile. The at least one similarity may be determined between at least one attribute of the first job profile and at least one attribute of the second job profile. The attributes of the first job profile and the second job profile comprise a title, an associated company, a category, an associated set of skills, a seniority level, an industry identification, any other suitable attribute of the job profile, or combinations thereof.

In some instances, operation 420 is performed using a set of sub-operations. In some example embodiments, the set of sub-operations comprises determining a similarity between the first job profile and the at least one second job profile. The similarity may be determined from at least one attribute of the first job profile and the second job profile. For example, in some embodiments, the similarity component 220 identifies the at least one second job profile by identifying a job title for the first job profile. The similarity component 220 then identifies job titles of a set of job profiles of the social networking system 100. The similarity component 220 compares the job titles for the set of job profiles to the job title for the first job profile. Upon determining sufficient similarity between job titles, the similarity component 220 selects the at least one second job profile from the set of job profiles based on the similarity between job titles of the at least one second job profile and the first job profile. In some instances, the similarity component 220 determines the similarity between job titles by semantic analysis of the job titles for the first job profile and the at least one second job profile to determine that a semantic distance between the job titles is below a similarity threshold. In some instances, instead of semantic similarity or semantic distances, the job titles may be determined by other means, such as a Hamming distance. Although described with respect to job titles and a specific manner for determining similarity between job profiles, it should be understood that the similarity component 220 may use any attribute or set of attributes of the job profiles to determine similarity and any suitable method for calculating similarity given the selected attribute or attributes.

In some example embodiments, once the similarity component 220 has determined the similarity between the first job profile and the at least one second job profile, the similarity component 220 determines a similarity between the first set of members and the second set of members associated with the at least one second job profile. In these embodiments, the similarity component 220 identifies the second set of members which are associated with the at least one second job profile by identifying members, within the social networking system 100, having member profiles including the at least one second job profile or associated therewith. The similarity component 220 compares member profiles for the first set of members and member profiles of the second set of members using attributes associated with each member profile. The attributes may comprise skills, education levels, certificates, experience, seniority, geographic location, geographic region, industry, publications, posts, any other suitable attributes included in the member profile, or combinations thereof. The similarity component 220 may compare the member profiles by comparing identifications associated with each attribute, performing semantic analysis to identify a semantic distance between two or more attributes, or any other suitable comparison. Based upon the similarity determined between the first set of members and the second set of members, the similarity component 220 selects the at least one second job profile. For example, upon determining a similarity value between the first job profile and the at least one second job profile, and that one or more similarity values determined between the first set of members and the second set of members have suitable similarity scores (e.g., exceed a predetermined or dynamic threshold), the similarity component 220 selects the at least one second job profile.

In operation 430, the vector component 230 generates a vector model for the first job profile. The vector model identifies a set of hidden feature vectors for the first job profile. In some instances, the set of hidden feature vectors for the first job profile are elements common to the first set of members and the second set of members. As hidden feature vectors, the common elements are excluded from the first job profile and the at least one second job profile. In some embodiments, the vector component 230 generates the vector model for the first job profile using equations (1a), (1b), (1c), (1d), (2a), and (2b). Equations (1a), (1b), (1c), and (1d) may be performed by a first sub-component of the vector component 230 and equations (2a) and (2b) may be performed by a second sub-component of the vector component 230. In some instances, the first sub-component and the second sub-component operate contemporaneously or nearly contemporaneously. As will be explained in more detail below, convergence of values generated by the first sub-component and the second sub-component generates and fits the vector model.

In some example embodiments, operation 430 is performed using a set of sub-operations. The set of sub-operations comprises determining first regression coefficients and a first hidden feature vector. In some embodiments, the first regression coefficients and the first hidden feature vector are determined jointly for the first set of members. In some instances, the first regression coefficients comprise a vector coefficient and a variance coefficient. The vector coefficient indicates a similarity of the first set of members to the first job profile. The variance coefficient controls a variance of a distribution from which the first hidden feature vector is selected.

In some embodiments, the sub-operations of operation 430 comprise the vector component 230 determining second regression coefficients and a second hidden feature vector. In some embodiments, the second regression coefficients and the second hidden feature vector are determined jointly for the second set of members. In some instances, the second regression coefficients comprise a vector coefficient and a variance coefficient. The vector coefficient indicates a similarity of the second set of members to the first job profile. The variance coefficient controls a variance of a distribution from which the second hidden feature vector is selected.

Although described separately, in some embodiments, the vector component 230 performs the sub-operations for determining the first regression coefficients and the first hidden feature vector and the sub-operations for determining the second regression coefficients and the second hidden feature vector as a single set of sub-operations for performing operation 430. Further, in some embodiments, the vector component 230 determines the first regression coefficients and the first hidden feature vector jointly for the first set of members and determines the second regression coefficients and the second hidden feature vector jointly for the second set of members in a single set of sub-operations for performing operation 430.

As referenced above, in embodiments using a first sub-component and a second sub-component of the vector component 230, the first sub-component generates the first regression coefficients and the second regression coefficients. The second sub-component generates (e.g., identifies) the first hidden feature vector and the second hidden feature vector.

In operation 440, the recommendation component 240 determines a job recommendation based on the first job profile, the at least one second job profile, the vector model for the first job profile, and a selected member profile of the social networking system 100. In some example embodiments, the recommendation component 240 receives the first hidden feature vector and the second hidden feature vector from the vector model. The recommendation component 240 compares the first and second hidden feature vectors to a set of job profiles within the social networking system 100. Upon identifying attributes associated with the first and second hidden feature vectors within or associated with one or more job profiles of the set of job profiles, the recommendation component 240 selects the one or more job profiles as a recommendation set. In some embodiments, the recommendation component 240 compares the first and second hidden feature vectors to a set of member profiles within the social networking system 100. Upon identifying attributes associated with the first and second hidden feature vectors within or associated with one or more member profiles of the set of member profiles, the recommendation component 240 identifies one or more job profiles associated with the one or more member profiles. The recommendation component 240 selects the associated one or more job profiles for inclusion in the recommendation set. In some instances, the recommendation component 240 orders the recommendation set for presentation at a computing device of a selected member. In some embodiments, the recommendation component 240 selects a portion of the recommendation set for presentation at the computing device of the selected member.

In operation 450, the interface component 250 causes presentation of the job recommendation on a display device communicatively coupled to a hardware processor of a computing device associated with the selected member. In some instances, the interface component 250 causes presentation of the job recommendation (e.g., one or more job profiles of the recommendation set) on the display device by transmitting the set of job profiles or a representation thereof for incorporation and display within a user interface presented on the display device. In some instances, the interface component 250 causes presentation of the job recommendation by generating a user interface screen or one or more user interface elements for inclusion in an existing user interface screen. The interface component 250 causes transmission of the user interface screen or the one or more user interface elements. Receipt of the user interface screen or the one or more user interface elements causes the computing device of the selected member to render and display the user interface screen or one or more user interface elements on the display device.

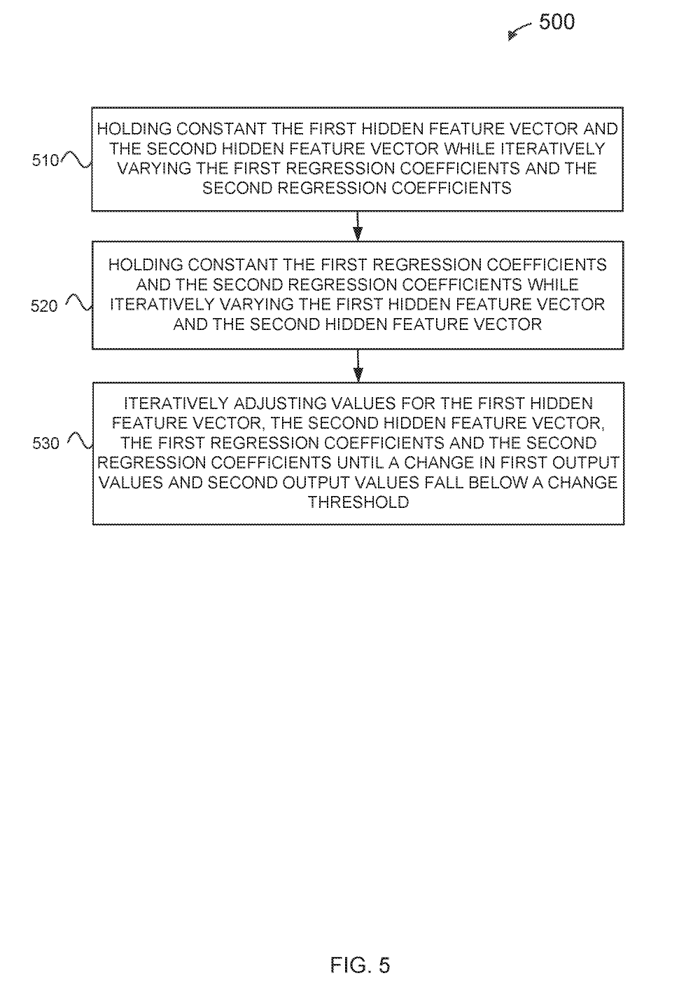

FIG. 5 illustrates a method 500 of determining regression coefficients and a hidden feature vector of a hierarchical structure, in accordance with some embodiments. The operations of method 500 may be performed by components of the job recommendation engine 112. In some instances, certain operations of the method 500 may be performed using one or more operations of the method 400 or as sub-operations of one or more operations of the method 400, as will be explained in more detail below.

In operation 510, the vector component 230 holds constant the first hidden feature vector and the second hidden feature vector while iteratively varying the first regression coefficients and the second regression coefficients. In some embodiments, the vector component 230 iterates values of the first regression coefficients and the second regression coefficients in equations (1a), (1b), (1c), and (1d) during operation 510. In instances where the vector component 230 comprises the first sub-component and the second sub-component, the first sub-component cooperates to iterate the first regression coefficients and the second regression coefficients while the second sub-component holds constant the values for the first hidden feature vector and the second hidden feature vector. In some instances, the vector component 230 tracks the values resulting from iterations of the first regression coefficients and the second regression coefficients to generate a regression value set.

In operation 520, the vector component 230 holds constant the first regression coefficients and the second regression coefficients while iteratively varying the first hidden feature vector and the second hidden feature vector. In some embodiments, the vector component 230 iterates values of the first hidden feature vector and the second hidden feature vector in equations (2a) and (2b) during operation 520. In instances where the vector component 230 comprises the first sub-component and the second sub-component, the second sub-component cooperates to iterate the first hidden feature vector and the second hidden feature vector while the first sub-component holds constant the values for the first regression coefficients and the second regression coefficients. In some instances, the vector component 230 tracks the values resulting from iterations of the first hidden feature vector and the second hidden feature vector to generate a feature value set.

In operation 530, the vector component 230 iteratively adjusts values for the first hidden feature vector, the second hidden feature vector, the first regression coefficients, and the second regression coefficients until a change in first output values (e.g., the regression value set) and second output values (e.g., the feature value set) fall below a change threshold. The first output values are generated from iteratively adjusting the first hidden feature and the second hidden feature vector, as described above with respect to operation 510. The second output values are generated from iteratively adjusting the first regression coefficients and the second regression coefficients, as described above with respect to operation 520. In some embodiments, the vector component iteratively adjusts the first hidden feature vector, the second hidden feature vector, the first regression coefficients, and the second regression coefficients according to a Bayesian method, deriving an expectation maximization from iterative adjustment of the values. The expectation maximization may be based on a determined approximate solution indicated by a convergence of the output values (e.g., the change between the output values falling below the change threshold). In some instances, maximizing the likelihood of p(D|ϕ) is equivalent to maximizing the log likelihood, L(D|ϕ)=ln p(D|ϕ).

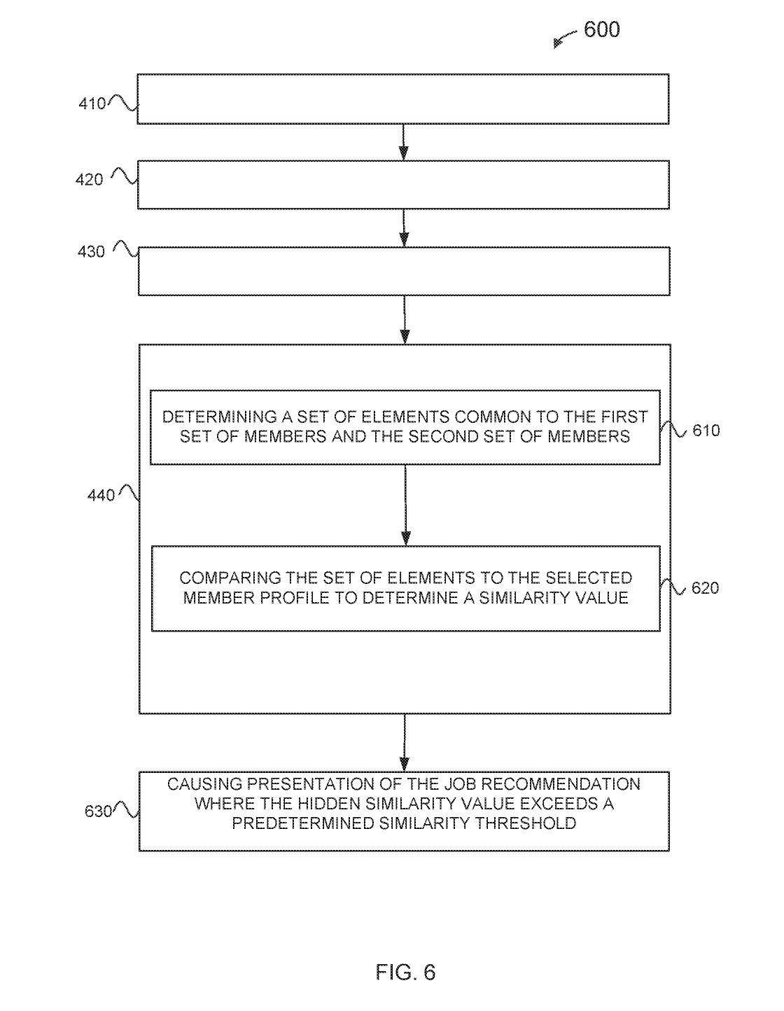

FIG. 6 illustrates a method 600 of determining regression coefficients and a hidden feature vector of using a machine learning model, in accordance with some embodiments. The method 600 may be performed, at least in part, by the job recommendation engine 112 or components thereof. In some embodiments, the method 600 includes one or more operations of the method 400 or 500. In some instances, one or more operations of the method 600 are performed as parts or sub-operations of one or more operations of the method 400 or 500. For example, as shown in FIG. 6, at least a portion of the operations of method 600 are performed as sub-operations or parts of operation 440 of method 400.

In operation 610, the recommendation component 240 determines a set of elements common to the first set of members and the second set of members. The set of elements are excluded from the first job profile and the at least one second job profile. In some embodiments, the recommendation component 240 determines the set of elements using the vector model described above with respect to methods 400 and 500. In some embodiments, the set of elements comprise one or more of a title, an associated company, a category, an associated set of skills, a seniority level, an industry identification, any other suitable attribute of the job profile, or combinations thereof. The recommendation component 240 may determine the set of elements as a set of features represented by the first hidden feature vector and the second hidden feature vector or a set of hidden feature vectors. The set of elements may be output by the vector model or a component of the vector model. For example, in some instances, the output of one or more of equations (2a), (2b), or (6) comprises the set of hidden feature vectors.

In operation 620, the recommendation component 240 compares the set of elements to the selected member profile to determine a hidden similarity value. The hidden similarity value may represent a similarity between the set of elements and the attributes listed within the selected member profile. In some instances, the hidden similarity value is determined as a percentage of the attributes included in the selected member profile which are also included in the set of elements. The hidden similarity value may also be determined as a ratio of common elements, a semantic distance, a Hamming distance, or any other value indicating a similarity between the set of elements and the attributes of the selected member profile. In some embodiments, the hidden similarity value is determined as a match (e.g., a synonym relationship) between an element of the set of elements (e.g., a word or words) and an aspect (e.g., a word or words) occurring in the selected member profile. The match may be determined as an exact match, a relative match representing a synonym relationship indicated by the dictionary of synonyms, or any other suitable match.

In operation 630, the interface component 250 causes presentation of the job recommendation where the hidden similarity value exceeds a predetermined similarity threshold. In some embodiments, the interface component 250 presents the job recommendation in a manner similar to or the same as the manner described with respect to operation 450. In some embodiments, the interface component 250 causes presentation of the job recommendation comprising a single job. The interface component 250 may also present the job recommendation comprising a plurality of jobs. In these instances, operations 610 and 620 may be performed for a plurality of job profiles. Job profiles associated with hidden similarity values exceeding a predetermined threshold may be presented within the job recommendation. In some instances, where the job recommendation comprises a plurality of job profiles, the job profiles are ordered according to their respective hidden similarity values.

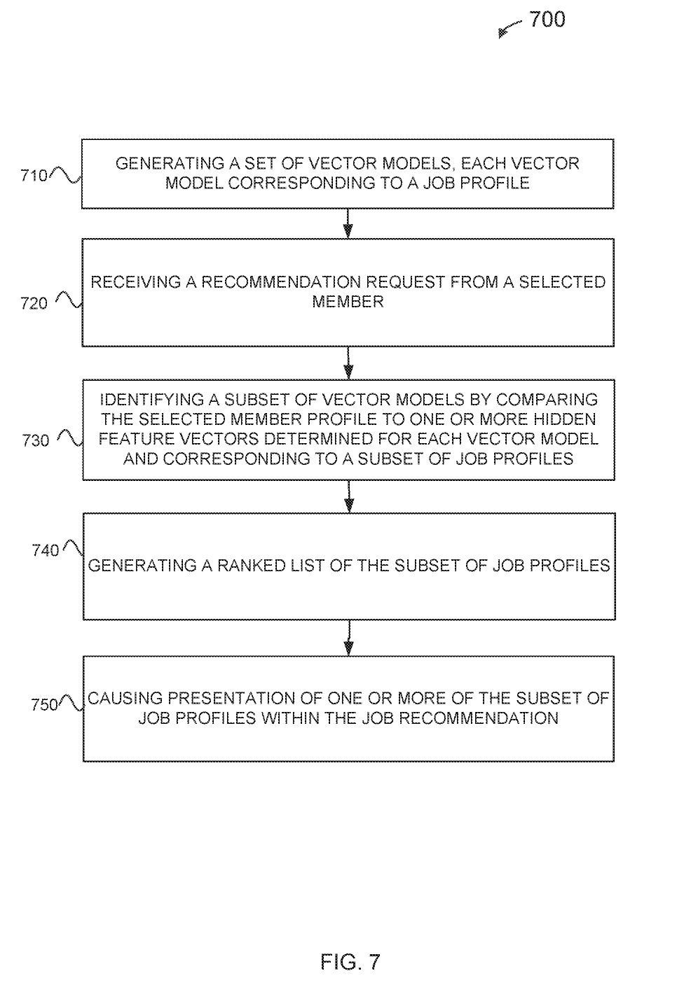

FIG. 7 illustrates a method 700 of determining regression coefficients and a hidden feature vector of a hierarchical structure in accordance with some embodiments. The method 700 may be performed, at least in part, by the job recommendation engine 112 or components thereof. In some embodiments, the method 700 includes one or more operations of the method 400, 500, or 600. In some instances, one or more operations of the method 700 are performed as parts or sub-operations of one or more operations of the method 400, 500, or 600.

In operation 710, the vector component 230 generates a set of vector models within the social networking system 100. Each vector model of the set of vector models corresponds to a different job profile of the social networking system 100. The vector models generate outputs comprising at least one set of hidden feature vectors for each job profile. In some embodiments, the vector component 230 periodically updates, regenerates, or otherwise adjusts the set of vector models. A vector model of the set of vector models may be updated periodically, based on a movement metric, upon changes to associated member profiles exceeding a change threshold, or according to any other suitable timeframe or metric. In some instances, the movement metric indicates a number of members of the social networking system 100 who terminated association (e.g., changed a member profile) with a job profile associated with a specified vector model in favor of another job profile associated with a different vector model. Updating based on the movement metric may be triggered after a number of members of the social networking system 100 exceeding a member threshold change associations with one job profile to another job profile. In some embodiments, the changes to associated member profiles comprise changes to attributes (e.g., skills, experience, etc.) without changing an association away from the job profile. In these instances, where a number of members exceeding a member threshold make changes to their respective member profiles, without changing job profile associations, the vector component 230 updates the vector model for the specified job profile.

In operation 720, the interface component 250 receives a recommendation request from a selected member. In some example embodiments, the interface component 250 receives the recommendation request from a computing device associated with the selected member. The association between the device and the member may be based on a login to the social networking system 100 from the computing device using credentials of the selected member, based on a device identification for the computing device, or any other suitable basis. In some embodiments, the computing device receives selection of a user interface element indicating the recommendation request. The user interface element may be associated with a recommendation request, associated with a job search option (e.g., tab, link, or button), or any other indication that the specified user is interested in a job recommendation. For example, as described above, in cooperation with the application server modules 110, the interface component 250 may receive a portion of the behavior data 124. The portion of the behavior data 124 may include a change to an attribute of a member profile (e.g., a change in job title or inclusion of a closing date of a term of employment with a current employer), selection of job announcements (e.g., clicking or saving job announcements), applying to a job or otherwise responding to a job announcement, or entering job search terms. Upon receiving selection of the user interface element, the computing device transmits the recommendation request to the interface component 250. The interface component 250 passes an indication of the recommendation request to one or more components of the job recommendation engine 112. In some instances, the interface component 250 causes the vector component 230 to initiate operations to identify vector models matching the member profile of the selected member.

In operation 730, the vector component 230 identifies a subset of vector models of the set of vector models by comparing the selected member profile to one or more hidden feature vectors determined for each vector model of the set of vector models. The subset of vector models corresponds to a subset of job profiles on the social networking system 100. In some embodiments, the vector component 230 identifies the subset of vector models using hidden similarity values similar to the manner described above with respect to operation 620. In some instances, the vector component 230 parses the hidden feature vectors for each model, identifying vector models having one or more hidden feature vector matching an attribute of the member profile for the selected member. The vector component 230 identifies vector models, and associated job profiles, having a number of matching hidden feature vectors exceeding a match threshold.

In operation 740, the recommendation component 240 generates a ranked list of the subset of job profiles. The ranked list of the subset of job profiles corresponds to the subset of vector models identified in operation 730. The ranked list corresponds to an order for the subset of vector models determined by the recommendation component 240. In some embodiments, the recommendation component 240 receives identifications for job profiles associated with each vector model of the subset of vector models. The recommendation component 240 also receives an indication of a relative similarity of the vector model to the member profile of the selected member (e.g., hidden similarity value or number of matching attributes). The recommendation component 240 generates an order for the job profiles based on the indication of the relative similarities of the vector models to generate the ranked list. The recommendation component 240 then passes the ranked list to the interface component 250.

In operation 750, the interface component 250 causes presentation of one or more of the subset of job profiles within the job recommendation. In embodiments where two or more of the subset of job profiles are presented, the two or more job profiles are presented according to the respective positions of each job profile within the ranked list generated in operation 740. In some instances, the interface component 250 causes presentation of the ranked list, or one or more job profiles from the ranked list, within the job recommendation in a manner similar to or the same as described above with respect to operation 450 or operation 630.

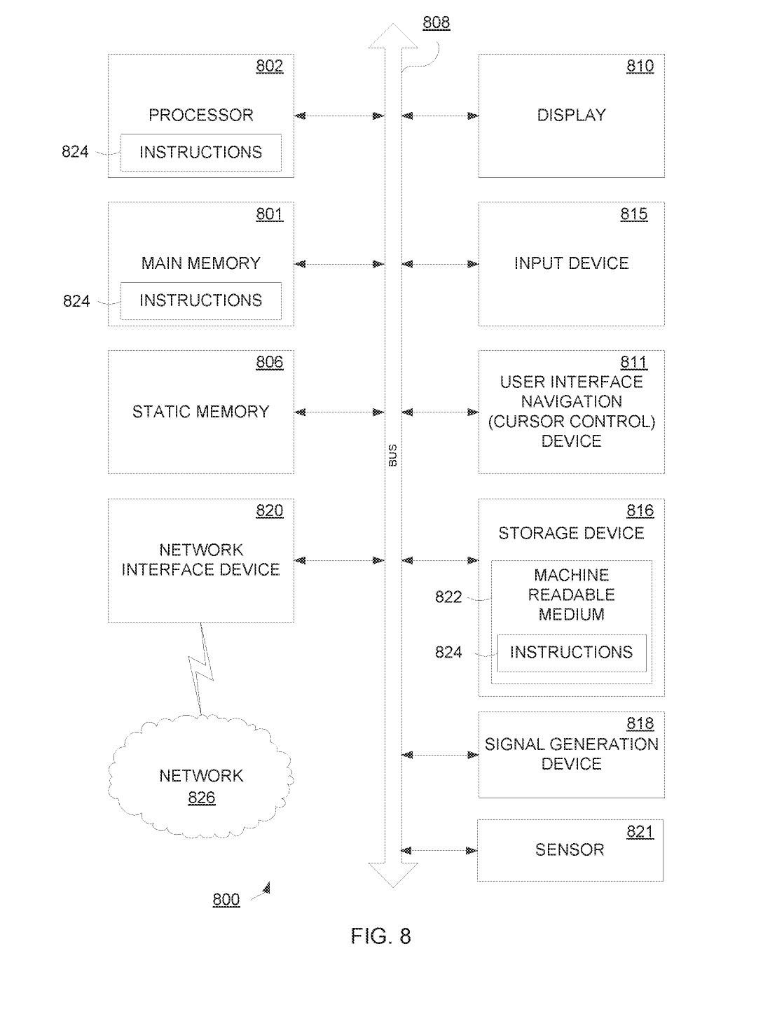

FIG. 8 shows a diagrammatic representation of the machine 800 in the example form of a computer system and within which instructions 824 (e.g., software) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 801, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 815 (e.g., a keyboard), a cursor control device 811 (e.g., a mouse, a touchpad, a trackball, a joystick, a motion sensor, or other pointing instrument), a storage unit 816 (e.g., storage device 816), a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The following examples pertain to further embodiments and combinations of the above-described embodiments. Specifics in the examples may be used in one or more embodiments. To better illustrate the apparatus and methods disclosed herein, a non-limiting list of examples is provided here:

1. A method of generating a job recommendation, the method including: selecting a first job profile, the first job profile associated with a first set of members of a social networking system; identifying at least one second job profile, the at least one second job profile associated with a second set of members of the social networking system; generating a vector model for the first job profile, the vector model identifying a set of hidden feature vectors for the first job profile; determining a job recommendation based on the first job profile, the at least one second job profile, the vector model for the first job profile, and a selected member profile of the social networking system; and causing presentation of the job recommendation on a display device communicatively coupled to a hardware processor of a computing device associated with the selected member profile.

2. The method of example 1, wherein identifying the at least one second job profile further comprises determining a similarity between the first job profile and the at least one second job profile from at least one attribute of the first job profile and the second job profile; and determining a similarity between the first set of members and the second set of members.

3. The method of examples 1 or 2, wherein generating the vector model further comprises determining first regression coefficients and a first hidden feature vector jointly for the first set of members; and determining second regression coefficients and a second hidden feature vector jointly for the second set of members.

4. The method of any one or more of examples 1-3, wherein the first regression coefficients comprise a vector coefficient and a variance coefficient, the vector coefficient indicating a similarity of the first set of members to the first job profile and the variance coefficient controlling a variance of a distribution from which the first hidden feature vector is selected.

5. The method of any one or more of examples 1-4, wherein the second regression coefficients comprise a vector coefficient and a variance coefficient, the vector coefficient indicating a similarity of the second set of members to the first job profile and the variance coefficient controlling a variance of a distribution from which the second hidden feature vector is selected.

6. The method of any one or more of examples 1-5, wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

7. The method of any one or more of examples 1-6, wherein determining the job recommendation further comprises determining, using the vector model, a set of elements common to the first set of members and the second set of members and excluded from the first job profile and the at least one second job profile; comparing the set of elements to the selected member profile to determine a hidden similarity value; and causing presentation of the job recommendation where the hidden similarity value exceeds a predetermined similarity threshold.

8. The method of any one or more of examples 1-7, further comprising generating a set of vector models, within the social networking system, for a vector model of the set of vector models corresponding to a different job profile of the social networking system; receiving a recommendation request from the selected member; identifying a subset of vector models of the set of vector models by comparing the selected member profile to one or more hidden feature vectors determined for each vector model of the set of vector models, the subset of vector models corresponding to a subset of job profiles on the social networking system; generating a ranked list of the subset of job profiles corresponding to the identified subset of vector models; and causing presentation of one or more of the subset of job profiles within the job recommendation.

9. The method of any one or more of examples 1-8, wherein the set of hidden feature vectors for the first job profile comprises elements common to the first set of members and the second set of members and excluded from the first job profile and the at least one second job profile.

10. A system comprising one or more processors; and a processor-readable storage device comprising processor-executable instructions that, when executed by the one or more processors, cause the one or more processors to perform operations comprising: selecting a first job profile, the first job profile associated with a first set of members of a social networking system, identifying at least one second job profile, the at least one second job profile associated with a second set of members of the social networking system; generating a vector model for the first job profile, the vector model identifying a set of hidden feature vectors for the first job profile; determining a job recommendation based on the first job profile, the at least one second job profile, the vector model for the first job profile, and a selected member profile of the social networking system; and causing presentation of the job recommendation on a display device communicatively coupled to a hardware processor of a computing device associated with the selected member profile.

11. The system of example 10 wherein identifying the at least one second job profile further comprises determining a similarity between the first job profile and the at least one second job profile from at least one attribute of the first job profile and the second job profile; and determining a similarity between the first set of members and the second set of members.

12. The system of examples 10 or 11 wherein generating the vector model further comprises determining first regression coefficients and a first hidden feature vector jointly for the first set of members; and determining second regression coefficients and a second hidden feature vector jointly for the second set of members.

13. The system of any one or more of examples 10-12, wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

14. The system of any one or more of examples 10-13, wherein determining the job recommendation further comprises determining, using the vector model, a set of elements common to the first set of members and the second set of members and excluded from the first job profile and the at least one second job profile; comparing the set of elements to the selected member profile to determine a hidden similarity value; and causing presentation of the job recommendation where the hidden similarity value exceeds a predetermined similarity threshold.

15. The system of any one or more of examples 10-14, wherein the operations further comprise generating a set of vector models, within the social networking system, for a vector model of the set of vector models corresponding to a different job profile of the social networking system; receiving a recommendation request from the selected member; identifying a subset of vector models of the set of vector models by comparing the selected member profile to one or more hidden feature vectors determined for each vector model of the set of vector models, the subset of vector models corresponding to a subset of job profiles on the social networking system; generating a ranked list of the subset of job profiles corresponding to the identified subset of vector models; and causing presentation of one or more of the subset of job profiles within the job recommendation.

16. A processor-readable storage device comprising processor-executable instructions that, when executed by one or more processors of a machine, cause the machine to perform operations comprising selecting a first job profile, the first job profile associated with a first set of members of a social networking system; identifying at least one second job profile, the at least one second job profile associated with a second set of members of the social networking system; generating a vector model for the first job profile, the vector model identifying a set of hidden feature vectors for the first job profile; determining a job recommendation based on the first job profile, the at least one second job profile, the vector model for the first job profile, and a selected member profile of the social networking system; and causing presentation of the job recommendation on a display device communicatively coupled to a hardware processor of a computing device associated with the selected member profile.

17. The processor-readable storage device of example 16, wherein identifying the at least one second job profile further comprises determining a similarity between the first job profile and the at least one second job profile from at least one attribute of the first job profile and the second job profile; and determining a similarity between the first set of members and the second set of members.

18. The processor-readable storage device of examples 16 or 17, wherein generating the vector model further comprises determining first regression coefficients and a first hidden feature vector jointly for the first set of members; and determining second regression coefficients and a second hidden feature vector jointly for the second set of members.

19. The processor-readable storage device of any one or more of examples 16-18, wherein generating the vector model further comprises holding constant the first hidden feature vector and the second hidden feature vector while iteratively varying the first regression coefficients and the second regression coefficients; holding constant the first regression coefficients and the second regression coefficients while iteratively varying the first hidden feature vector and the second hidden feature vector; and iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

20. The processor-readable storage device of any one or more of examples 16-19, wherein the operations further comprise generating a set of vector models, within the social networking system, for a vector model of the set of vector models corresponding to a different job profile of the social networking system; receiving a recommendation request from the selected member; identifying a subset of vector models of the set of vector models by comparing the selected member profile to one or more hidden feature vectors determined for each vector model of the set of vector models, the subset of vector models corresponding to a subset of job profiles on the social networking system; generating a ranked list of the subset of job profiles corresponding to the identified subset of vector models; and causing presentation of one or more of the subset of job profiles within the job recommendation.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of generating a job recommendation, the method comprising:
selecting a first job profile, the first job profile associated with a first set of members of a social networking system;
identifying at least one second job profile, the at least one second job profile associated with a second set of members of the social networking system;
generating a vector model for the first job profile, the vector model identifying a set of hidden feature vectors for the first job profile;
determining a job recommendation based on the first job profile, the at least one second job profile, the vector model for the first job profile, and a selected member profile of the social networking system; and
causing presentation of the job recommendation on a display device communicatively coupled to a hardware processor of a computing device associated with the selected member profile.

2. The method of claim 1, wherein identifying the at least one second job profile further comprises:
determining a similarity between the first job profile and the at least one second job profile from at least one attribute of the first job profile and the at least one second job profile; and
determining a similarity between the first set of members and the second set of members.

3. The method of claim 1, wherein generating the vector model further comprises:
determining first regression coefficients and a first hidden feature vector jointly for the first set of members; and
determining second regression coefficients and a second hidden feature vector jointly for the second set of members.

4. The method of claim 3, wherein the first regression coefficients comprise a vector coefficient and a variance coefficient, the vector coefficient indicating a similarity of the first set of members to the first job profile and the variance coefficient controlling a variance of a distribution from which the first hidden feature vector is selected.

5. The method of claim 3, wherein the second regression coefficients comprise a vector coefficient and a variance coefficient, the vector coefficient indicating a similarity of the second set of members to the first job profile and the variance coefficient controlling a variance of a distribution from which the second hidden feature vector is selected.

6. The method of claim 3, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

7. The method of claim 1, wherein determining the job recommendation further comprises:
determining, using the vector model, a set of elements common to the first set of members and the second set of members and excluded from the first job profile and the at least one second job profile;
comparing the set of elements to the selected member profile to determine a hidden similarity value; and
causing presentation of the job recommendation where the hidden similarity value exceeds a predetermined similarity threshold.

8. The method of claim 1, further comprising:
generating a set of vector models, within the social networking system, for a vector model of the set of vector models corresponding to a different job profile of the social networking system;
receiving a recommendation request from the selected member;
identifying a subset of vector models of the set of vector models by comparing the selected member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.

9. The method of claim 1, wherein the set of hidden feature vectors for the first job profile are elements common to the first set of members and the second set of members and excluded from the first job profile and the at least one second job profile.

10. A system comprising:
one or more processors; and
a processor-readable storage device comprising processor-executable instructions that, when executed by the one or more processors, causes the one or more processors to perform operations comprising:
selecting a first job profile, the first job profile associated with a first set of members of a social networking system;
identifying at least one second job profile, the at least one second job profile associated with a second set of members of the social networking system;
generating a vector model for the first job profile, the vector model identifying a set of hidden feature vectors for the first job profile;
determining a job recommendation based on the first job profile, the at least one second job profile, the vector model for the first job profile, and a selected member profile of the social networking system; and
causing presentation of the job recommendation on a display device communicatively coupled to a hardware processor of a computing device associated with the selected member profile.

11. The system of claim 10, wherein identifying the at least one second job profile further comprises:
determining a similarity between the first job profile and the at least one second job profile from at least one attribute of the first job profile and the at least one second job profile; and
determining a similarity between the first set of members and the second set of members.

12. The system of claim 10, wherein generating the vector model further comprises:
determining first regression coefficients and a first hidden feature vector jointly for the first set of members; and
determining second regression coefficients and a second hidden feature vector jointly for the second set of members.

13. The system of claim 12, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

14. The system of claim 10, wherein determining the job recommendation further comprises:
determining, using the vector model, a set of elements common to the first set of members and the second set of members and excluded from the first job profile and the at least one second job profile;
comparing the set of elements to the selected member profile to determine a hidden similarity value; and
causing presentation of the job recommendation where the hidden similarity value exceeds a predetermined similarity threshold.

15. The system of claim 10, wherein the operations further comprise:
generating a set of vector models, within the social networking system, for a vector model of the set of vector models corresponding to a different job profile of the social networking system;
receiving a recommendation request from the selected member;
identifying a subset of vector models of the set of vector models by comparing the selected member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.

16. A processor-readable storage device comprising processor-executable instructions that, when executed by one or more processors of a machine, cause the machine to perform operations comprising:
selecting a first job profile, the first job profile associated with a first set of members of a social networking system;
identifying at least one second job profile, the at least one second job profile associated with a second set of members of the social networking system;
generating a vector model for the first job profile, the vector model identifying a set of hidden feature vectors for the first job profile;
determining a job recommendation based on the first job profile, the at least one second job profile, the vector model for the first job profile, and a selected member profile of the social networking system; and
causing presentation of the job recommendation on a display device communicatively coupled to a hardware processor of a computing device associated with the selected member profile.

17. The processor-readable storage device of claim 16, wherein identifying the at least one second job profile further comprises:
determining a similarity between the first job profile and the at least one second job profile from at least one attribute of the first job profile and the at least one second job profile; and
determining a similarity between the first set of members and the second set of members.

18. The processor-readable storage device of claim 16, wherein generating the vector model further comprises:
determining first regression coefficients and a first hidden feature vector jointly for the first set of members; and
determining second regression coefficients and a second hidden feature vector jointly for the second set of members.

19. The processor-readable storage device of claim 18, wherein generating the vector model further comprises:
holding constant the first hidden feature vector and the second hidden feature vector while iteratively varying the first regression coefficients and the second regression coefficients;
holding constant the first regression coefficients and the second regression coefficients while iteratively varying the first hidden feature vector and the second hidden feature vector; and
iteratively adjusting values for the first hidden feature vector, the second hidden feature vector, the first regression coefficients, and the second regression coefficients until a change in first output values and second output values falls below a change threshold, the first output values generated from iteratively adjusting the first hidden feature vector and the second hidden feature vector, the second output values generated from iteratively adjusting the first regression coefficients and the second regression coefficients.

20. The processor-readable storage device of claim 16, wherein the operations further comprise:
generating a set of vector models, within the social networking system, for a vector model of the set of vector models corresponding to a different job profile of the social networking system;
receiving a recommendation request from the selected member;
identifying a subset of vector models of the set of vector models by comparing the selected member profile to one or more hidden feature vectors determined for each vector model of the set of vector models, the subset of vector models corresponding to a subset of job profiles on the social networking system;
generating a ranked list of the subset of job profiles corresponding to the identified subset of vector models; and
causing presentation of one or more of the subset of job profiles within the job recommendation.
